(19) United States
(12) Patent Application Publication
(10) Pub. No.: US 2002/0130704 A1
(43) Pub. Date: Sep. 19, 2002

(54) Charge pump circuit

(76) Inventors: Takao Myono, Saitama (JP); Akira Uemoto, Gunma (JP)

Correspondence Address: CHRIS T. MIZUMOTO, Fish & Richardson P.C., Suite 2800, 45 Rockfeller Plaza, New York, NY, 10111, US

(21) Appl. No.: 10/061,858

(22) Filed: Feb. 1, 2002

(30) Foreign Application Priority Data
Feb. 1, 2001 (JP) JPA2001-025153
Feb. 1, 2001 (JP) JPA2001-025154

(51) Int. Cl. G05F 1/10

(52) U.S. Cl. 327/536

(57) ABSTRACT

Provided are level shift circuits S1-S4 to on/off-control a charge-transfer MOS transistor M1-M4 depending upon a clock pulse, and a branched charge pump circuit BC branched from an intermediate stage of a charge pump circuit to output a positive boost voltage. By using each-staged output V4, V5 of the branched charge pump circuit BC as a high-potential power to the level shift circuit S3, S4, the charge-transfer MOS transistors M1-M4 of the charge pump circuit when turning on are made in the gate-to-source voltages to nearly a constant value.

### BACKGROUND OF THE INVENTION

1. Field of the Invention

The present invention relates to a charge pump circuit and, more particularly, to a charge pump circuit enabled for high efficiency and large current output.

2.Description of the Related Art

The recent video apparatus, such as video cameras, digital still cameras (DSC) and DSC phones, uses a CCD (Charge Coupled Device) in order to capture images. The CCD drive circuit for driving the CCD requires a power source circuit high in positive/negative voltage (in or around a range of 10 to 20V) and great in current (several mA). At present, the high voltage is generated by the use of a switching regulator.

The switching regulator can generate high voltage at high performance, i.e. high electric power efficiency (output power/input power) . However, this circuit has a defect to cause harmonic noises during current switching and must be used with power source circuit shielding. Furthermore, a coil is required as an external part.

On the other hand, the charge pump circuit can generate high voltage with less noise but has a defect of worse electric power efficiency conventionally. This accordingly cannot be used as a power source circuit for a portable apparatus having the specification placing the priority on electric power efficiency. Consequently, a high-performance charge pump circuit if realized can contribute to the size reduction in the portable apparatus.

There is known a Dickson charge pump circuit as a conventional, most basic charge pump circuit. This circuit is described in detail, for example, in a technical document “John F. Dickson On-chip High-Voltage Generation inMNOS Integrated Circuits Using an Improved Voltage Multiplier Technique, IEEE JOURNAL OF SOLID-STATE CIRCUITS. VOL. SC-11, No. 3 pp. 374-378 JUNE 1976”.

FIG. 21 is a schematic circuit diagram showing a four-staged Dickson charge pump circuit. In FIG. 21, five diodes are connected in series. Cis a coupling capacitance, CL is an output capacitance, and CLK and CLKB are input clock pulses opposite in phase to each other. Meanwhile, 51 is a clock driver and 52 a current load.

In the case a constant current Iout flows to the output in a stable state, the input current to the charge pump circuit is constituted by a current from input voltage Vin and a current supplied from a clock driver. These currents, if neglecting a charge/discharge current to/from the parasitic capacitance, are as follows. During the period of φ1=High and φ2=Low, a mean current of 2Iout flows in a direction of the solid-lined arrow in the figure.

Meanwhile, during the period of φ1=Low and φ2=High, a mean current of 2Iout flows in a direction of the broken-lined arrow in the figure. These mean currents in a clock cycle are all Iout. The boost voltage Vout on a charge pump circuit in a stable state is expressed by the following.

Vₒᵤₜ=Vᵢₙ−V_{d}+n(V_{φ}′−V₁−V_{d}) (1)

where V_{φ}′ is a voltage amplitude caused by a coupling capacitance due to change in clock pulse at each connection node. V₁ is a voltage drop caused by an output current Iout. Vᵢₙ is an input voltage to be usually given by a power-source voltage Vdd in usual positive boosting and 0 V in negative boosting. V_{d} is a forward bias diode voltage, and n is the number of pumping stages. Furthermore, V₁ and V_{φ}′ are expressed by the following equation.

$$\begin{matrix}{V}_{l} = \frac{{I}_{out}}{f ( C + Cs )} = \frac{2 {I}_{out} T / 2}{C + Cs} & ( 2 ) \\ {V}_{φ}^{′} = {V}_{φ} \frac{C}{C + Cs} & ( 3 )\end{matrix}$$

where C is a clock coupling capacitance, Cₛ is a stray parasitic capacitance at each node, V_{φ} is a clock pulse amplitude, f is a clock pulse frequency and T is a clock period. The electric power efficiency on the charge pump circuit, if neglecting a charge/discharge current flowing from clock driver to parasitic capacitance be neglected and giving Vin=Vdd, is expressed by the following equation.

$$η = \frac{{V}_{out} {I}_{out}}{( n + 1 ) {V}_{dd} {I}_{out}} = \frac{{V}_{out}}{( n + 1 ) {V}_{dd}} \qquad ( 4 )$$

In this manner, the charge pump circuit uses diodes as a charge transfer device to transfer the charges one after another to the next stage, thereby performing boosting. However, considering mounting onto a MOS integrated circuit, it is easy to realize by using MOS transistors rather than using pn-junction diodes in view of the adaptation to the process. For this reason, proposal has been made to use, as a charge transfer device, MOS transistors in place of diodes. In this case, Vd in equation (1) is a MOS transistor threshold voltage Vth.

In the meanwhile, in order to eliminate the voltage loss in the amount of threshold voltage Vth and realize a high-performance charge pump circuit, the impedance of the charge-transfer MOS transistor must be decreased correspondingly to the value of Iout. For this purpose, it is effective to optimize the channel width of the charge-transfer MOS transistor and, at the same time, increase the gate-to-source voltage Vgs to the power source voltage Vdd or the higher. The charge pump circuit realizing the above is described in detail, for example, in a technical document “Jieh-Tsorng Wu MOS Charge Pumps for Low-Voltage Operation, IEEE JOURNAL OF SOLID-STATE CIRCUITS. VOL. 33, NO. 4 APRIL 1998.”

Considering the charge pump circuit of the foregoing technical document, the present inventor has found the following problem. In FIG. 22 is shown a circuit diagram of one charge pump circuit described in the document. In the figure, MD1-MD4 are the diodes for initially setting respective pump nodes, having no contribution to pumping action. This circuit has a feature that 2 Vdd is provided by returning the voltage on the rear-staged pumping node boosted as a gate-to-source voltage Vgs for the charge-transfer MOS transistor MS1-MS3. However, there is a difficulty in providing, as Vgs, 2 Vdd to the final-staged charge-transfer MOS transistor MS4, unavoidably causing voltage loss.

Another charge pump circuit described in the document is a dynamic-schemed charge pump circuit shown in FIG. 23. This circuit uses a high-voltage clock generator of a boot-strap scheme in order to avoid the loweing in Vgs on the MOS transistor MD4 down to Vdd+(Vdd−Vth) and further Vgs on the MOS transistor MD0 down to (Vdd−Vth). Meanwhile, all the charge-transfer MOS transistors MS1-MS4 are of the N-channel configuration.

This scheme is effective because, when the current load is small, the charge-transfer MOS transistor is small in size, i.e. gate parasitic capacitance is small. However, in order to realize a charge pump circuit having large current output, the channel width of the charge-transfer MOS transistor must be made in several mm. As a result, the gate parasitic capacitance on the MOS transistor is increased (several pF), making it difficult to produce a 2 Vdd clock by the boot-strap scheme. Meanwhile, there has been a defect to separately devise a technique for applying a voltage of a power source voltage Vdd or the higher as a source-to-drain voltage Vgs of a later-staged charge-transfer MOS transistor.

### SUMMARY OF THE INVENTION

The present invention has been made in order to solve the problem in the conventional art, and it is an object to provide a charge pump circuit high in efficiency and large in output current by eliminating the voltage loss resulting from the threshold voltage Vth of the charge-transfer MOS transistor.

Also, another object of the invention is to make nearly a constant value the gate-to-source voltages Vgs of all the charge-transfer MOS transistors thereby securing a gate-oxidation-film with standing voltage and enabling the optimal design for a charge-transfer MOS transistor.

A charge pump circuit of the present invention comprises: a plurality of charge-transfer transistors connected in series; a coupling capacitor having one end connected to each connecting point of the charge-transfer transistors; a clock driver for supplying opposite-phased clock pulses alternately to the other end of the coupling capacitor; a branched charge pump circuit provided branched from the connection point of the charge-transfer transistors; and a control circuit for on/off-controlling the charge-transfer transistor depending upon an output of the branched charge pump circuit.

According to the structure, when the charge-transfer transistor is turned on by the control circuit, a level-shifted high gate voltage is supplied depending upon a boost output from the branched charge pump circuit. Accordingly, an efficient, high output-current charge pump circuit can be provided which is eliminated of the voltage loss resulting from the threshold voltage Vth of the charge-transfer transistor.

Meanwhile, by making the gate-to-source voltage Vgs absolute values of all the charge-transfer transistors to nearly a constant value (e.g. 2 Vdd), it is possible to stably secure a breakdown strength in agate oxide film and optimally design a charge-transfer transistor.

Meanwhile, a charge pump circuit of the invention is, in a charge pump having a plurality of P-channel charge-transfer MOS transistors connected in series having a first-staged charge-transfer MOS transistor to be applied by a predetermined external voltage, a plurality of coupling capacitors each having one end connected to each connection point of the charge-transfer MOS transistor, and a clock driver for supplying opposite-phased clock pulses to the other end of the coupling capacitor, thereby outputting a positive boost voltage from the rear-staged charge-transfer MOS transistor, characterized by providing a plurality of level shift circuits for on/off-controlling the charge-transfer MOS transistor of the charge pump circuit depending on the clock pulse, and supplying each-staged output of the charge pump circuit as a higher-potential power to the level shift circuit.

According to this structure, when the charge-transfer MOS transistor is turned on by the level shift circuit, a level-shifted high gate voltage is supplied. Accordingly, an efficient, high output-current charge pump circuit can be provided which is eliminated of the voltage loss resulting from the threshold voltage Vth of the charge-transfer MOS transistor.

Meanwhile, because every charge-transfer MOS transistor is configured by a single-channel type, the number of manufacture processes can be reduced.

### BRIEF DESCRIPTION OF THE DRAWINGS

FIG. 1 is a circuit diagram showing a charge pump circuit according to a first embodiment of the present invention.

FIGS. 2A through 2C are diagrams showing the configuration and operating waveform of a level shift circuit.

FIG. 3 is a timing chart for explaining the operation of the charge pump circuit according to the first embodiment of the invention.

FIG. 4. is a chart showing a voltage waveform at each pumping node of the charge pump circuit according to the first embodiment of the invention.

FIG. 5 is a circuit diagram showing a charge pump circuit according to a second embodiment of the invention.

FIG. 6 is a timing chart for explaining the operation of the charge pump circuit according to the second embodiment of the invention.

FIG. 7 is a chart showing a voltage waveform at each pumping node of the charge pump circuit according to the second embodiment of the invention.

FIG. 8 is a circuit diagram showing a charge pump circuit according to a third embodiment of the invention.

FIGS. 9A through 9C are diagrams showing the configuration and operating waveform of a level shift circuit.

FIG. 10 is a timing chart for explaining the operation of the charge pump circuit according to the third embodiment of the invention.

FIG. 11 is a chart showing a voltage waveform at each pumping node of the charge pump circuit according to the third embodiment of the invention.

FIG. 12 is a circuit diagram showing a charge pump circuit according to a fourth embodiment of the invention.

FIG. 13 is a circuit diagram showing a charge pump circuit according to a fifth embodiment of the invention.

FIG. 14 is a circuit diagram showing a charge pump circuit according to a sixth embodiment of the invention.

FIG. 15 is a circuit diagram showing a charge pump circuit according to a seventh embodiment of the invention.

FIG. 16 is a timing chart for explaining the operation of the charge pump circuit according to the seventh embodiment of the invention.

FIG. 17 is a chart showing a voltage waveform at each pumping node of the charge pump circuit according to the seventh embodiment of the invention.

FIG. 18 is a circuit diagram showing a charge pump circuit according to an eighth embodiment of the invention.

FIG. 19 is a circuit diagram showing a charge pump circuit according to a ninth embodiment of the invention.

FIG. 20 is a circuit diagram showing a charge pump circuit according to a tenth embodiment of the invention.

FIG. 21 is a circuit diagram showing a charge pump circuit in a conventional example.

FIG. 22 is a circuit diagram showing a charge pump circuit in a conventional example.

FIG. 23 is a circuit diagram showing a charge pump circuit in a conventional example.

### DESCRIPTION OF THE PREFERRED EMBODIMENTS

(First Embodiment)

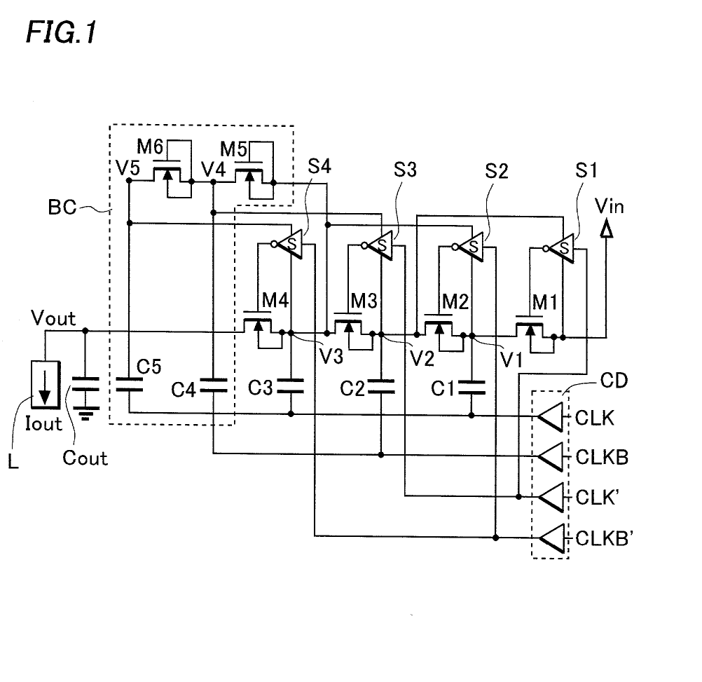

FIG. 1 is a circuit diagram showing a three-staged charge pump circuit according to a first embodiment of the present invention.

In FIG. 1, four charge-transfer MOS transistors M1-M4 are connected in series. M1-M4 are all of the N-channel type. M1-M4 are connected to be the same potential at the source and substrate so that a gate-to-substrate voltage Vgb is the same in value as a gate-to-source voltage Vgs. This is to suppress the back-gate bias effect in the MOS transistor. Meanwhile, a power voltage Vdd is supplied as an input voltage Vin to the source of M1. Meanwhile, a positive boost voltage Vout is outputted from the drain of M4 and supplied to a current load L.

C1, C2 and C3 are coupling capacitors having one ends connected respectively to the connection points (pumping nodes) of the charge-transfer MOS transistors M1 through M4. The coupling capacitors have the other ends to be applied alternately by a clock pulse CLK and a clock pulse CLKB opposite in phase thereto. The clock pulses CLK, CLKB are supplied through a clock driver CD. Herein, provided that the power voltage of the clock driver CD is Vdd, the clock pulse CLK, CLKB has an amplitude of Vdd.

An output of a level shift circuit S1-S4 (control circuit) is supplied to each gate of the charge-transfer MOS transistor M1-M4. The level shift circuits S1-S4 have the same circuit configuration as hereinafter referred, to be inputted alternately by clock pulses CLK′, CLKB′. The clock pulses CLK′, CLKB′ are similarly supplied through the clock driver CD.

Meanwhile, two charge-transfer MOS transistors M5, M6 are connected in series, which are branched from the connection point of the charge-transfer MOS transistors M3 and M4. The charge-transfer MOS transistors M5, M6 are each connected between the gate and source, thereby configuring diodes. The coupling capacitor C4 at its one end is connected to the connection point of M5 and M6. A clock pulse CLKB is applied to the other end of the coupling capacitor C4. Meanwhile, one end of the coupling capacitor C5 is connected to the source of M6. The clock pulse CLK is applied to the other end of the coupling capacitor C5.

The circuit, formed by the above charge-transfer MOS transistors M5, M6 and coupling capacitors C4, C5, is a Dickson type charge pump circuit. Each of M5 and M6 is of the N-channel type. This circuit, because being branched from a third stage of the charge pump circuit, is hereinafter referred to as a branched charge pump circuit BC. The branched charge pump circuit BC is used to supply a higher-potential power to the level shift circuit S3, S4.

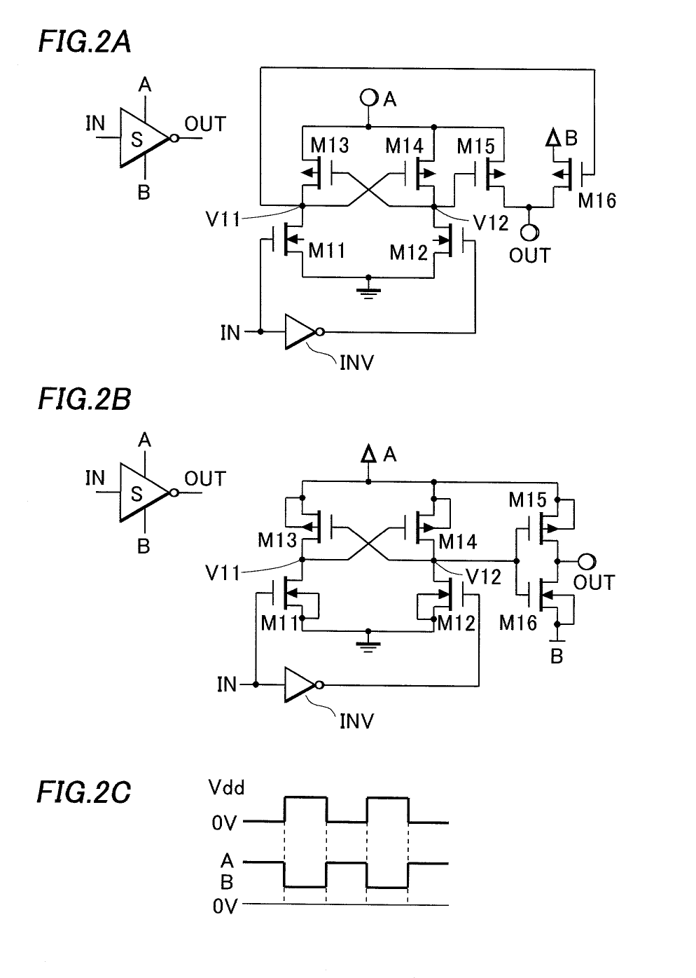

Next, the circuit configuration and operating waveform diagram of the level shift circuit S1-S4 is shown in FIG. 2. As shown in FIG. 2A, this level shift circuit has an input inverter INV, differential input MOS transistors M11 and M12 and cross-connected MOS transistors M13 and M14.

This level shift circuit has, in addition to them, MOS transistors M15, M16 in pull-up connection. The MOS transistor M15 is applied, at a gate, by a voltage V12 and, at a source, by a potential A (higher-potential power).

Meanwhile, the MOS transistor M16 is applied, at a gate, by a voltage V11 opposite in polarity to V12 and, at a source, by a potential B (lower-potential power). Herein, potential A>potential B. M11 and M12 are of the N-channel type while M13-M16 are of the P-channel type.

Meanwhile, in the level shift circuit in the above configuration, the MOS transistors M15, M16 may be modified to an inverter configuration as shown in FIG. 2B. The operation waveform on the level shift circuit configured as above is shown in FIG. 2C.

As compared to the outputting of a high voltage and 0 V in the conventional level shift circuit, this level shift circuit is characterized to output alternately a potential A and an intermediate potential B (A>B>0 V) . This level shift circuit, if seen in the phase relationship between input voltage and output voltage, is an inverter circuit. By using the level shift circuit described above, it is possible to make even to nearly a constant voltage (2Vdd) the gate-to-drain voltage absolute values of the charge-transfer MOS transistors M1-M4, as hereinafter referred.

The connection relationship between the level shift circuits S1-S4 and the charge pump is as follows. The level shift circuit S1 is inputted by a clock pulse CLK′, using a potential V2 of a connection point of M2 and M3 as a higher-potential power and an input voltage Vin (=Vdd) as a lower-potential power. Namely, the level shift circuit S1 outputs “V2” to the gate of M1 when the clock pulse CLK′ is at a low level. This turns M1 on. Meanwhile, when the clock pulse CLK′ is at a high level, “Vdd” is outputted to the gate of M1. This turns M1 off.

The level shift circuit S2 is inputted by a clock pulse CLKB′, using a potential V3 of a connection point of M3 and M4 as a higher-potential power and a potential V1 of a connection point of M1 and M2 as a lower-potential power. Namely, the level shift circuit S2 outputs “V3” to the gate of M2 when the clock pulse CLKB′ is at a low level. This turns M2 on. Meanwhile, when the clock pulse CLKB′ is at a high level, “V1” is outputted to the gate of M1. This turns M2 off.

The level shift circuit S3 is inputted by a clock pulse CLK′, using a potential V4 of a connection point of M5 and M6 outputted by the branched charge pump circuit BC as a higher-potential power and a potential V2 of a connection point of M2 and M3 as a lower-potential power. Namely, the level shift circuit S3 outputs “V4” to the gate of M3 when the clock pulse CLK′ is at a low level. This turns M3 on. Meanwhile, when the clock pulse CLKB′ is at a high level, “V2” is outputted to the gate of M3. This turns M3 off.

A clock pulse CLKB′ is inputted to the level shift circuit S4, using a drain potential V5 of M6 as a higher-potential power and a potential V3 of a connection point of M3 and M4 as a lower-potential power. Namely, the level shift circuit S4 outputs “V5” to the gate of M4 when the clock pulse CLKB′ is at a low level. This turns M4 on. Meanwhile, when the clock pulse CLKB′ is at a high level, “V3” is outputted to the gate of M4. This turns M4 off.

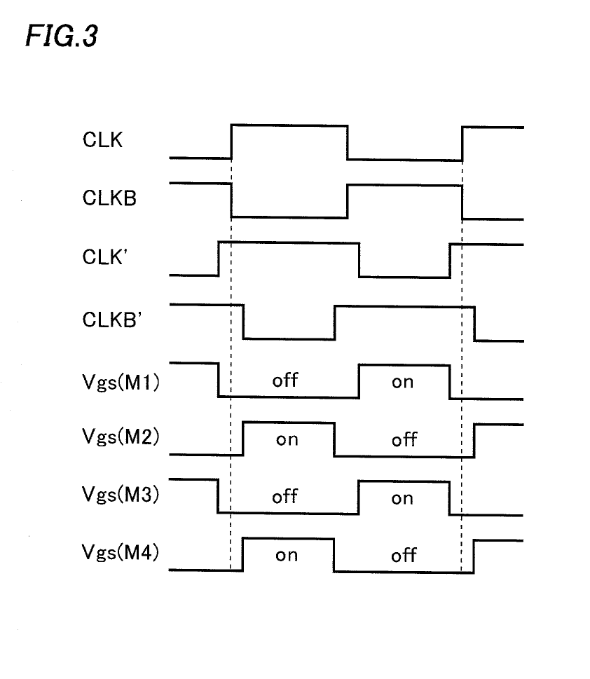

Incidentally, although the clock pulses CLK′ and CLKB′ are respectively generated from the clock pulses CLK and CLKB, the low period is given shorter in order to prevent the reverse flow of a current to the charge-transfer MOS transistors M1-M4. The charge-transfer MOS transistors M1-M4, because of not in diode-connection, have a danger to flow a reverse current that worsens power efficiency. Accordingly, in order to prevent such a reverse current, the charge-transfer MOS transistors M1-M4 are shortened in on-period to change the clock pulses CLK, CLKB applied to the coupling capacitors C1-C3 during the off period, thereby performing pumping. The phase relationship between such clock pulses is shown in FIG. 3.

According to the charge pump circuit configured as above, it is derived that the gate-to-source voltage Vgs absolute values (inon-state of the transistor) of the charge-transfer transistors M1-M4 can be made even to nearly 2 Vdd, as in the following. First, the relationship of the following equations is held.

Vgs (M1)=V2−Vin

Vgs (M2)=V3−V1

Vgs (M3)=V4−V2

Vgs (M4)=V5−V3

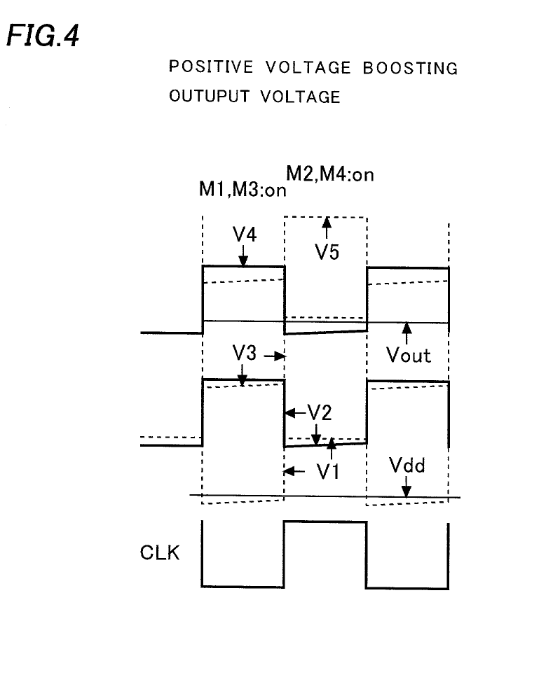

Next, consideration is made on the boost operation of the charge pump in a steady state. FIG. 4 is a chart showing voltage waveforms V1, V2, V3 and Vout at respective pumping nodes. As apparent from the chart, when M1 and M3 are on (CLK′=L), V1=Vdd, V2=3 Vdd and V3=3 Vdd.

Meanwhile, in the branched charge pump circuit BC, V4=5 Vdd−Vth and V5=5 Vdd−2 Vth. Herein, Vth is a threshold voltage of the charge-transfer transistor M5, M6.

On the other hand, when M2 and M4 are on (CLKB′=L), V1=2 Vdd, V2=2 Vdd and V3=4 Vdd. Meanwhile, in the branched charge pump circuit BC, V4=4 Vdd−Vth and V5=6 Vdd−2 Vth.

Accordingly, the followings hold:

Vgs (when M1 is on)=V2−Vin=2 Vdd,

Vgs (when M2 is on)=V3−V1=2 Vdd,

Vgs (when M3 is on)=V4−V2=2 Vdd−Vth,

and

Vgs (when M4 is on)=V5−V3=2 Vdd−2 Vth.

In this manner, it is derived that the absolute values of all the charge-transfer MOS transistors during on are nearly the same value as 2 Vdd. Accordingly, high Vgs decreases the on-state resistance of the charge-transfer MOS transistor M1-M4, thus realizing a charge pump circuit having high efficiency and large output current. Meanwhile, because the charge-transfer MOS transistors M1-M4 may be designed in gate-oxide film to a thickness for withstanding 2 Vdd, it is possible to efficiently design with low on-state resistance as compared to the case of uneven Vgs of the charge-transfer MOS transistors.

Although explanation was made above on the three-staged charge pump circuit according to the embodiment of the invention, the number of stages thereof is not limited to three. Meanwhile, although it was shown in the three-staged charge pump circuit that the Vgs absolute values of the charge-transfer MOS transistors are to be made even to nearly 2 Vdd, it is possible in a multi-staged charge pump circuit to make even the Vgs absolute values to 3 Vdd or the greater.

For this purpose, the higher-potential power to the level shift circuit S1-S4 may utilize a voltage of a connection node at a further rear stage. However, the absolute value of 2 Vdd is best suited if considering the breakdown voltage of gate oxide.

(Second Embodiment)

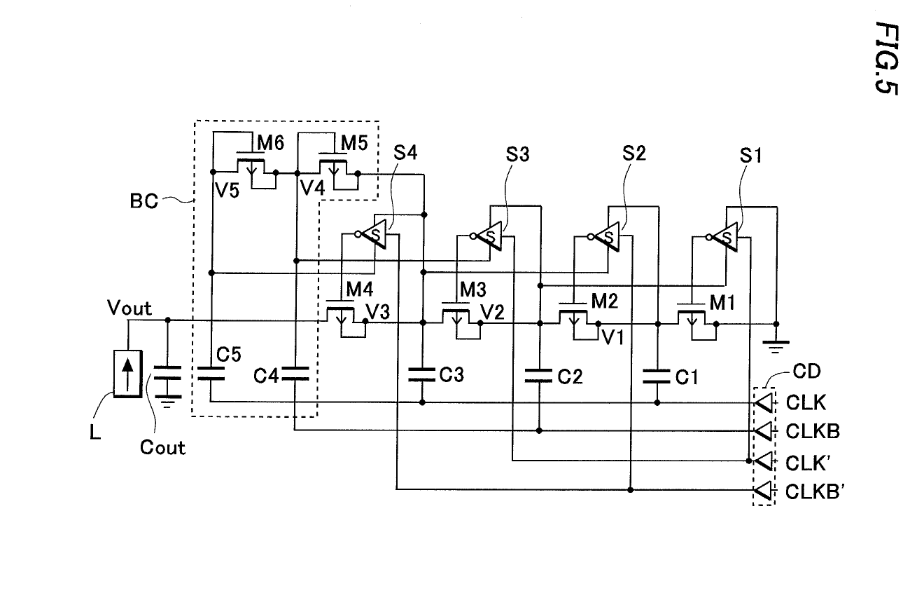

Next, explanation is made on a charge pump circuit according to a second embodiment of the invention. Although the foregoing charge pump circuit is to perform positive boosting, FIG. 5 is a circuit diagram showing a three-staged charge pump circuit for negative boosting (boosting to 0 V or the lower). This charge pump circuit is to output a boost voltage of −3 Vdd.

In FIG. 5, four charge-transfer MOS transistors M1-M4 are connected in series. M1-M4 are all of the P-channel type. M1-M4 are connected to be the same potential at the source and substrate so that a gate-to-substrate voltage Vgb is the same in value as a gate-to-source voltage Vgs. Meanwhile, a ground voltage Vss (=0 V) is supplied as an input voltage Vin to the source of M1. In this respect, this embodiment is configured reverse in polarity to the charge pump circuit according to the first embodiment. A negative boost voltage Vout (=−3 Vdd) is outputted from the drain of M4 and supplied to a current load L.

C1, C2 and C3 are coupling capacitors having one ends connected respectively to the connection points (pumping nodes) of the charge-transfer MOS transistors M1-M4. The coupling capacitors have the other ends to be applied alternately by a clock pulse CLK and a clock pulse CLKB opposite in phase thereto. The clock pulses CLK, CLKB are supplied through a clock driver CD. In this respect, this embodiment is the same as the first embodiment.

An output of a level shift circuit S1-S4 (control circuit) is supplied to each gate of the charge-transfer MOS transistor M1-M4. The level shift circuits S1-S4 are quite the same in configuration as those explained in the first embodiment (FIG. 2). Meanwhile, clock pulses CLK′, CLKB′ are alternately inputted to the level shift circuits S1-S4. The clock pulses CLK′, CLKB′ are similarly supplied through the clock driver CD.

Two charge-transfer MOS transistors M5, M6 are connected in series, which are branched from a connection point of the charge-transfer MOS transistors M3 and M4. Each of M5 and M6 is of the P-channel type. The coupling capacitor C4 at its one end is connected to a connection point of M5 and M6. A clock pulse CLKB is applied to the other end of the coupling capacitor C4. Meanwhile, the one end of the coupling capacitor C5 is connected to the source of M6. The clock pulse CLK is applied to the other end of the coupling capacitor C5.

The circuit, formed by the above charge-transfer MOS transistors M5, M6 and coupling capacitors C4, C5, constitutes a branched charge pump circuit BC. The branched charge pump circuit BC is used as higher-potential power sources to the level shift circuits S3, S4.

The level shift circuits S1-S4 and the charge pump circuit are in a connection relationship, as follows. A clock pulse CLK′ is inputted to the level shift circuit S1, using a potential V2 of a connection point of M2 and M3 as a lower-potential power (potential B in FIGS. 2A, 2B and 2C) and an input voltage Vin (=0 V) as a higher-potential power (potential A in FIGS. 2A, 2B and 2C). Namely, the level shift circuit S1 outputs “V2” to the gate of M1 when the clock pulse CLK′ is at a high level. This turns M1 on. Meanwhile, when the clock pulse CLK′ is at a low level, “0 V” is outputted to the gate of M1. This turns M1 off.

The level shift circuit S2 is inputted by a clock pulse CLKB′, using a potential V3 of a connection point of M3 and M4 as a lower-potential power and a potential V1 of a connection point of M1 and M2 as a higher-potential power. Namely, the level shift circuit S2 outputs “V3” to the gate of M2 when the clock pulse CLKB′ is at a high level. This turns M2 on. Meanwhile, when the clock pulse CLKB′ is at a low level, “V1” is outputted to the gate of M1. This turns M2 off.

The level shift circuit S3 is inputted by a clock pulse CLK′, using a potential V4 of a connection point of M5 and M6 outputted by the branched charge pump circuit BC as a lower-potential power and a potential V2 of a connection point of M2 and M3 as a higher-potential power. Namely, the level shift circuit S3 outputs “V4” to the gate of M3 when the clock pulse CLK′ is at a high level. This turns M3 on. Meanwhile, when the clock pulse CLK′ is at a low level, “V2” is outputted to the gate of M3. This turns M2 off.

The level shift circuit S4 is inputted by a clock pulse CLKB′, using a drain potential V5 of M6 as a lower-potential power and a potential V3 of a connection point of M3 and M4 as a higher-potential power. Namely, the level shift circuit S4 outputs “V5” to the gate of M4 when the clock pulse CLKB′ is at a high level. This turns M4 on. Meanwhile, when the clock pulse CLKB′ is at a low level, “V3” is outputted to the gate of M4. This turns M4 off.

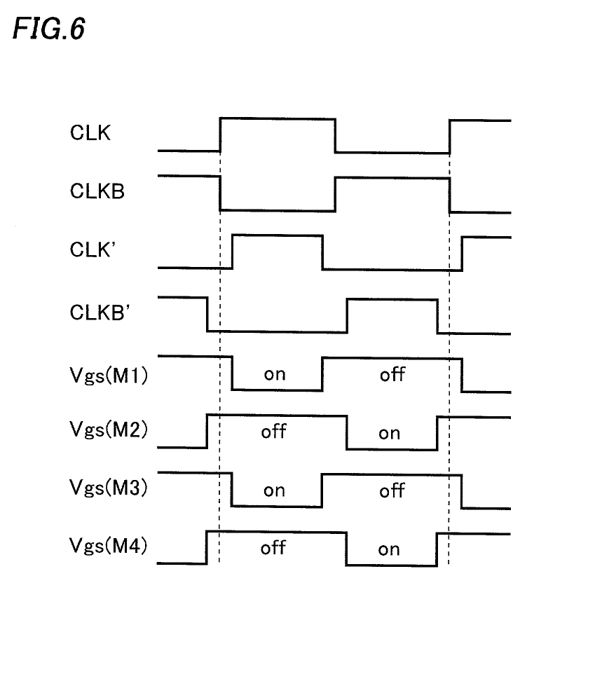

Incidentally, although the clock pulses CLK′ and CLKB′ are respectively produced from the clock pulses CLK and CLKB, the high period is given shorter in order to prevent the reverse flow of a current to the charge-transfer MOS transistors M1-M4. In this respect, this embodiment is reverse to the first embodiment. The charge-transfer MOS transistors M1-M4, because of not in diode-connection, have a danger to flow a reverse current that worsens power efficiency. Accordingly, in order to prevent such a reverse current, the charge-transfer MOS transistors M1-M4 are shortened in on-period to change the clock pulses CLK, CLKB applied to the coupling capacitors C1-C3 during the off period, thereby performing pumping. The phase relationship between such clock pulses is shown in FIG. 6.

According to the charge pump circuit configured as above, it is derived that the gate-to-source voltages Vgs absolute values (in on-state of the transistor) of the charge-transfer transistors M1-M4 can be made even to nearly 2 Vdd, as in the following. First, the relationship of the following equations is held. In this respect, this embodiment is the same as the first embodiment.

Vgs (M1)=V2−Vin=V2

Vgs (M2)=V3−V1

Vgs (M3)=V4−V2

Vgs (M4)=V5−V3

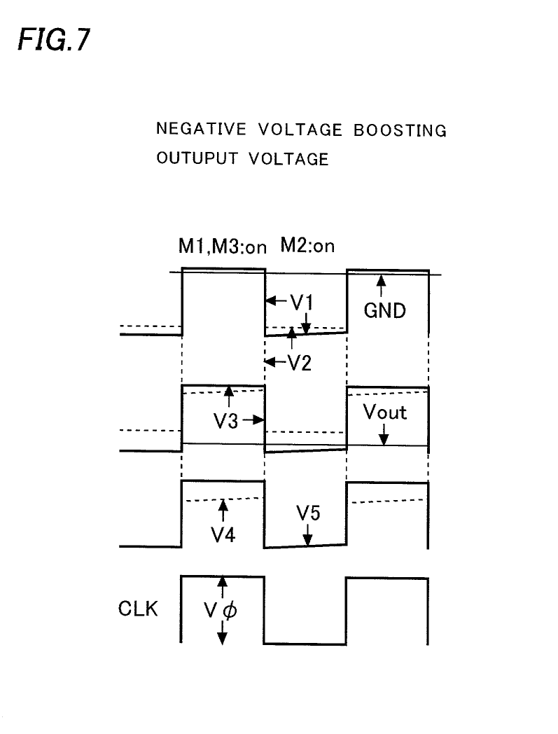

Next, consideration is made on the boost operation of the charge pump in a steady state. FIG. 7 is a chart showing the voltage waveforms V1, V2, V3 and Vout at respective pumping nodes. In the chart, the GND level is 0 V.

As apparent from the chart, when M1 and M3 are on (CLK′=H), V1=0, V2=−2 Vdd and V3=−2 Vdd. Meanwhile, in the branched charge pump circuit BC, V4=−4 Vdd+2 Vth and V5=−4 Vdd+2 Vth. Herein, Vth is a threshold voltage of the charge-transfer transistor M5, M6.

On the other hand, when M2 and M4 are on (CLKB′=H), V1=−Vdd, V2=−Vdd and V3=−3 Vdd. Meanwhile, in the branched charge pump circuit BC, V4=−3 Vdd+Vth and V5=−5 Vdd+2 Vth.

Accordingly, the followings holds:

Vgs (when M1 is on)=V2=−2 Vdd,

Vgs (when M2 is on)=V3−V1=−2 Vdd,

Vgs (when M3 is on)=V4−V2=−2 Vdd+Vth,

and

Vgs (when M4 is on)=V5−V3=−2 Vdd+2Vth.

In this manner, it is derived in the second embodiment that the absolute values of all the charge-transfer MOS transistors during “on” become nearly the same value of 2 Vdd. Accordingly, high Vgs decreases the on-state resistance of the charge-transfer MOS transistor M1-M4 similarly to the first embodiment, thus realizing a charge pump circuit having high efficiency and great output current. Meanwhile, because the charge-transfer MOS transistors M1-M4 may be designed in gate oxide to a thickness for withstanding 2 Vdd, it is possible to design to have high efficiency with lower on-state resistance as compared to the case of uneven Vgs on the charge-transfer MOS transistors.

Although explanation was made above on the three-staged charge pump circuit for outputting a negative boost voltage, the number of stages thereof is not limited to three. Meanwhile, although it was shown in the three-staged charge pump circuit that the Vgs absolute values of the charge-transfer MOS transistors can be made even to nearly 2 Vdd, it is possible in a multi-staged charge pump circuit to make even Vgs absolute values of the chrge-transfer MOS transistors to 3 Vdd or the greater.

For this purpose, the higher-potential power to the level shift circuit S1-S4 may utilize a voltage of a connection node at a further rear stage. However, the absolute value 2 Vdd is best suited if considering the breakdown voltage of gate oxide.

(Third Embodiment)

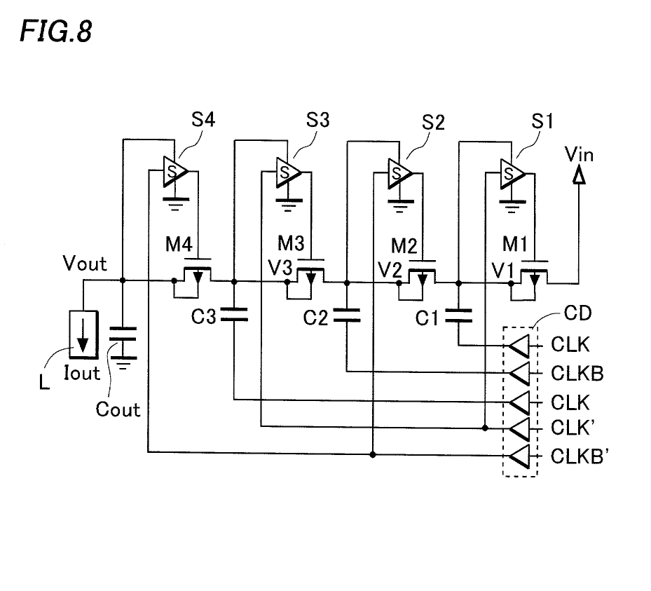

FIG. 8 is a circuit diagram showing a three-staged charge pump circuit according to a third embodiment of the invention.

In FIG. 8, four charge-transfer MOS transistors M1-M4 are connected in series. M1-M4 are all of the N-channel type. M1-M4 are connected to be the same potential at the source and substrate so that a gate-to-substrate voltage Vgb is the same in value as a gate-to-source voltage Vgs. This is to suppress the back-gate bias effect in the MOS transistor. Meanwhile, a power voltage Vdd (external voltage, e.g. +5 V) is supplied as an input voltage Vin to the source of M1. Meanwhile, a positive boost voltage Vout is outputted from the drain of M4 and supplied to a current load L.

C1, C2 and C3 are coupling capacitors having one ends connected respectively to the connection points (pumping nodes) of the charge-transfer MOS transistors M1-M4. The coupling capacitors have the other ends to be applied alternately by a clock pulse CLK and a clock pulse CLKB opposite in phase thereto. The clock pulses CLK, CLKB are supplied through a clock driver CD. Provided that the power voltage of the clock driver CD is Vdd, the clock pulse CLK, CLKB have an amplitude of Vdd.

An output of a level shift circuit S1-S4 is supplied to each gate of the charge-transfer MOS transistor M1-M4. The level shift circuits S1-S4 have the same configuration as hereinafter referred, to be inputted alternately by clock pulses CLK′, CLKB′. The clock pulses CLK′, CLKB′ are similarly supplied through the clock driver CD.

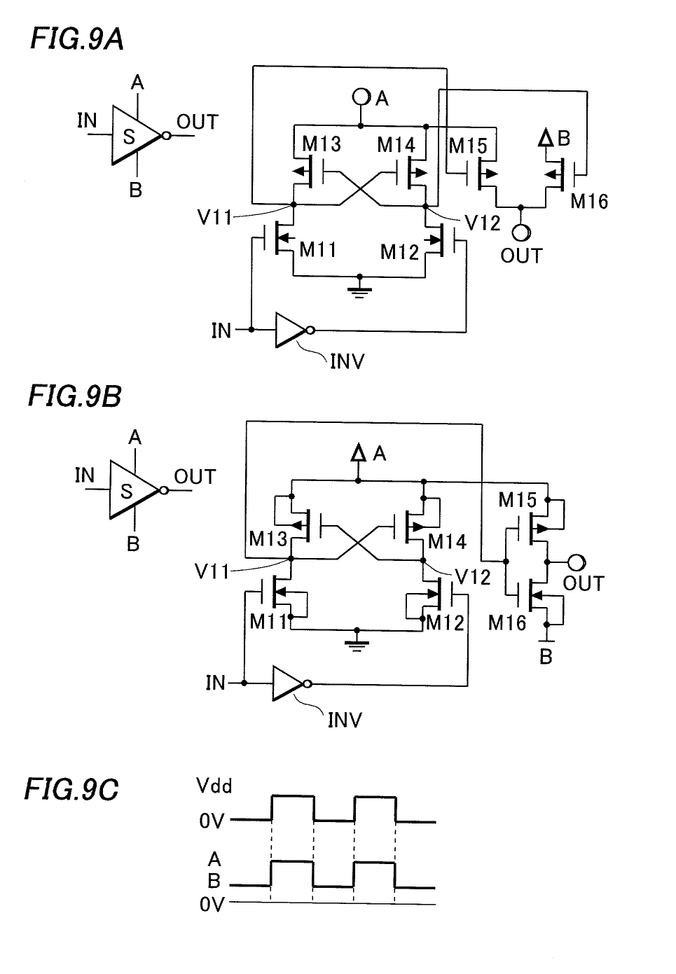

In FIGS. 9A through 9C is shown the circuit configuration and operating waveform diagram of the level shift circuit S1-S4. As shown in FIG. 9A, the level shift circuit has an input inverter INV, differential input MOS transistors M11 and M12, and cross-connected MOS transistors M13 and M14.

The level shift circuit has, in addition to these, MOS transistors M15, M16 in pull-up connection. A voltage V11 is applied to the gate of the MOS transistor M15 while a potential A (higher-potential power) is applied to the source thereof.

Meanwhile, a voltage V12 opposite in phase to V11 is applied to the gate of the MOS transistor M16 while a potential B (lower-potential power) is applied to the source thereof. Herein, potential A>potential B. M11, M12 are of the N-channel type whereas M13-M16 are of the P-channel type.

Meanwhile, in the level shift circuit, the MOS transistors M15, M16 may be modified to an inverter configuration as shown in FIG. 9B. In FIG. 9C is shown the operating waveform of the level shift circuit configured as above.

Contrary to the conventional level shift circuit for outputting high voltage and 0 V, the level shift circuit is characterized to output alternately a potential A and an intermediate potential B (A>B>0 V). This level shift circuit is a non-inverting circuit as seen in the relationship between input voltage and output voltage.

The level shift circuits S1-S4 and the charge pump circuit have a connection relationship as in the following. The level shift circuit S1 is inputted by a clock pulse CLK′, and supplied with a potential V1 of a connection point of M1 and M2 as a higher-potential power and a ground voltage (=0 V) as a lower-potential power. The level shift circuit S1 outputs “0 V” to the gate of M1 when the clock pulse CLK′ is at a low level. This turns M1 on. Meanwhile, when the clock pulse CLK′ is at a high level, “V1=2 Vdd” is outputted to the gate of M1. This turns M1 off.

The level shift circuit S2 is inputted by a clock pulse CLKB′, and supplied with a potential V2 of a connection point of M2 and M3 as a higher-potential power and a ground voltage (=0 V) as a lower-potential power. The level shift circuit S2 outputs “0 V” to the gate of M2 when the clock pulse CLKB′ is at a low level. This turns M2 on. Meanwhile, when the clock pulse CLKB′ is at a high level, “V2” is outputted to the gate of M1. This turns M2 off.

The level shift circuit S3 is inputted by a clock pulse CLK′, and supplied with a potential V3 of a connection point of M3 and M4 as a higher-potential power and a ground voltage (=0 V) as a lower-potential power. The level shift circuit S3 outputs “0 V” to the gate of M3 when the clock pulse CLK′ is at a low level. This turns M3 on. Meanwhile, when the clock pulse CLKB′ is at a high level, “V3” is outputted to the gate of M3. This turns M3 off.

The level shift circuit S4 is inputted by a clock pulse CLKB′, and supplied with Vout (=4 Vdd) as a higher-potential power and a ground voltage (=0 V) as a lower-potential power. The level shift circuit S4 outputs “0 V” to the gate of M4 when the clock pulse CLKB′ is at a low level. This turns M4 on. Meanwhile, when the clock pulse CLKB′ is at a high level, “Vout” is outputted to the gate of M4. This turns M4 off.

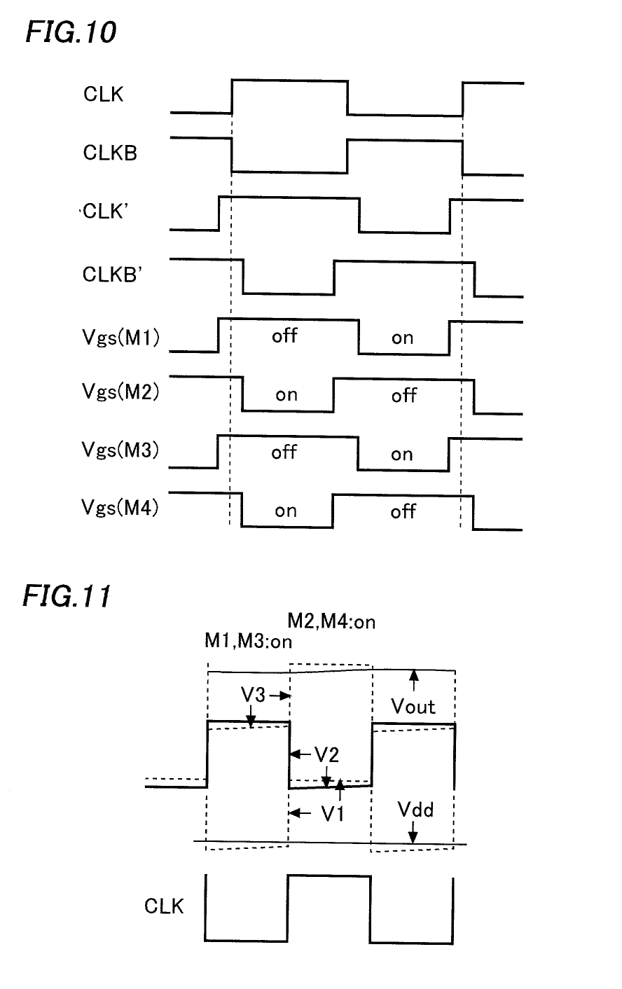

Incidentally, although the clock pulses CLK′ and CLKB′ are respectively produced from the clock pulses CLK and CLKB, the low period is given shorter in order to prevent the reverse flow of a current to the charge-transfer MOS transistors M1-M4. The charge-transfer MOS transistors M1-M4, because of not in diode-connection, have a danger to flow a reverse current that worsens power efficiency. Accordingly, in order to prevent such a reverse current, the charge-transfer MOS transistors M1-M4 are shortened in on-period to change the clock pulses CLK, CLKB applied to the coupling capacitors C1-C3 during the off period, thereby performing pumping. The phase relationship between such clock pulses is shown in FIG. 10.

According to the charge pump circuit configured as above, the gate-to-source voltages Vgs (in on-state of the transistor) in absolute value of the charge-transfer transistors M1-M4 are as in the following.

Vgs (M1)=0V−V1

Vgs (M2)=0V−V2

Vgs (M3)=0V−V3

Vgs (M4)=0V−V4

Next, consideration is made on the boost operation of the charge pump in a steady state. FIG. 11 is a chart showing the voltage waveforms V1, V2, V3 and Vout at respective pumping nodes. As apparent from the chart, when M1 and M3 are on (CLK′=L), V1=Vdd, V2=3 Vdd and V3=3 Vdd.

On the other hand, when M2 and M4 are on (CLKB′=L), V1=2 Vdd, V2=2 Vdd and V3=4 Vdd.

Accordingly, Vgs (when M1 is on)=−V1=−Vdd,

Vgs (when M2 is on)=−V2=−2 Vdd,

Vgs (when M3 is on)=−V3=−3 Vdd,

Vgs (when M4 is on)=−V4=−4 Vdd.

Accordingly, because high Vgs greater in absolute value than 2 Vdd is applied to M2-M4, on-state resistance is further reduced in M2-M4 thus realizing a charge pump circuit having high efficiency and large output current. Also, because the charge-transfer MOS transistors M1-M4 are all configured of the P-channel type, manufacture process can be shortened. Incidentally, this embodiment explained the three-staged charge pump circuit, the number of stages is not limited to three.

(Fourth Embodiment)

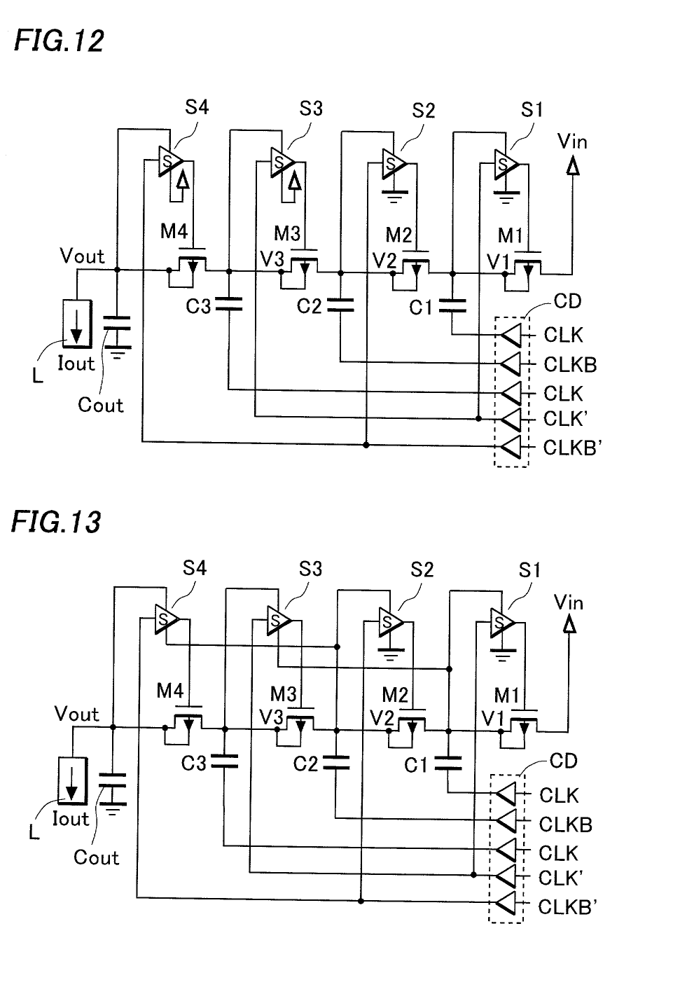

Next, explanation is made on a charge pump circuit according to a fourth embodiment of the invention with reference to FIG. 12. The difference from the third embodiment lies in that a power voltage Vdd (external voltage, e.g. +5 V) is supplied as a lower-potential power to the level shift circuit S3, S4.

Due to this, the gate-to-source voltages Vgs (in on-state of the transistor) of the charge-transfer transistors M1-M4 are as in the following.

Vgs (M1)=0V−V1

Vgs (M2)=0V−V2

Vgs (M3)=Vdd−V3

Vgs (M4)=Vdd−V4

Herein, the voltages V1, V2, V3, Vout at respective pumping nodes in a steady state are the same as those of the third embodiment (see FIG. 11).

Accordingly, the following hold:

Vgs (when M1 is on)=−V1=−Vdd,

Vgs (when M2 is on)=−V2=−2 Vdd,

Vgs (when M3 is on)=Vdd−V3=Vdd−3 Vdd=−2 Vdd,

and

Vgs (when M4 is on)=Vdd−V4=Vdd−4 Vdd=−3 Vdd.

In this manner, although the gate-to-source voltages Vgs in on-state of the charge-transfer transistors M1-M4 are not even, the difference can be made small as compared to the third embodiment. Accordingly, because the charge-transfer MOS transistors may be designed in gate oxide evenly to a thickness for withstanding 3 Vdd (absolute value), on-state resistance can be designed to have good efficiency with low resistance as compared to the third embodiment (more uneven in charge-transfer MOS transistor Vgs).

(Fifth Embodiment)

Next, explanation is made on a charge pump circuit according to a fifth embodiment of the invention with reference to FIG. 13. The difference from the third embodiment lies in that an intermediate-staged output V1, V2 of the charge pump circuit is supplied as a lower-potential power to the level shift circuit S3, S4.

Due to this, the gate-to-source voltages Vgs (in on-state of the transistor) of the charge-transfer transistors M1-M4 are as in the following.

Vgs (M1)=0V−V1

Vgs (M2)=0V−V2

Vgs (M3)=V1−V3

Vgs (M4)=V2−V4

Herein, the voltages V1, V2, V3, Vout at respective pumping nodes ina steady state are the same as those of the third embodiment (see FIG. 11).

Accordingly, the followings hold:

Vgs (when M1 is on)=−V1=−Vdd,

Vgs (when M2 is on)=−V2=−2 Vdd,

Vgs (when M3 is on)=V1−V3=Vdd−3 Vdd=−2 Vdd,

and

Vgs (when M4 is on)=V2−V4=2 Vdd−4 Vdd=−2 Vdd.

In this manner, the gate-to-source voltages Vgs can be provided as-Vdd only on M1 and −2 Vdd on all M2-M4. Accordingly, because the charge-transfer MOS transistors M1-M4 maybe designed gate oxide evenly to a thickness for withstanding 2 Vdd (absolute value), on-state resistance can be efficiently designed low as compared to the first and second embodiments (more uneven in charge-transfer MOS transistor Vgs).

(Sixth Embodiment)

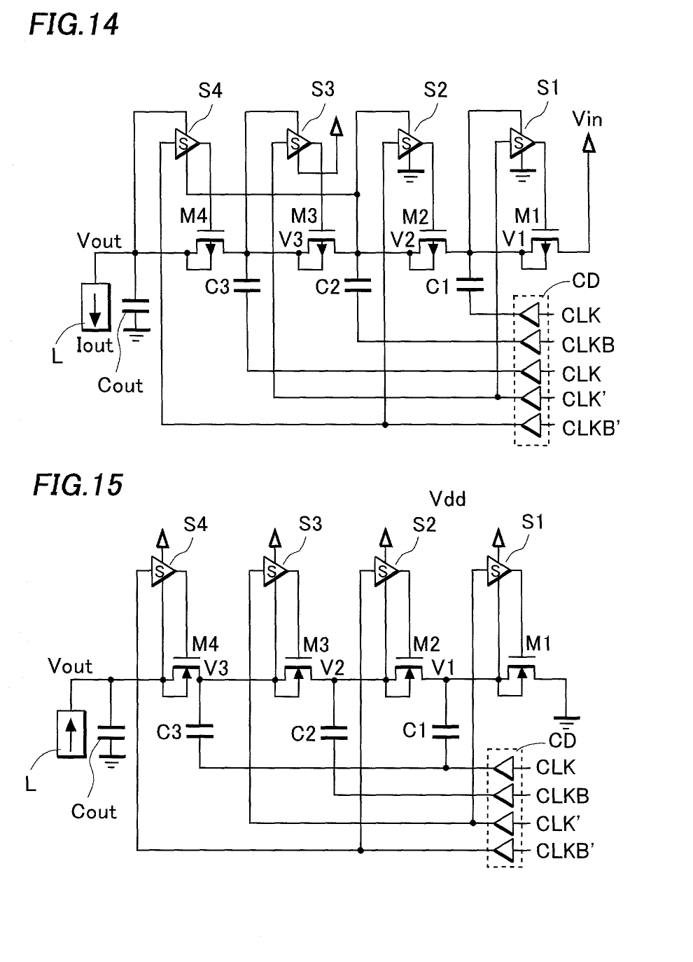

Next, explanation is made on a charge pump circuit according to a sixth embodiment of the invention with reference to FIG. 14. The difference from the third embodiment lies in that a power voltage Vdd is supplied as a lower-potential power to the level shift circuit S3 and an intermediate-staged output V2 of the charge pump circuit is supplied as a lower-potential power to the level shift circuit S4.

Due to this, the gate-to-source voltages Vgs (in on-state of the transistor) of the charge-transfer transistors M1-M4 are as in the following.

Vgs (M1)=0V−V1

Vgs (M2)=0V−V2

Vgs (M3)=Vdd−V3

Vgs (M4)=V2−V4

Herein, the voltages V1, V2, V3, Vout at respective pumping nodes ina steady state are the same as those of the third embodiment (see FIG. 11).

Accordingly, the followings hold:

Vgs (when M1 is on)=−V1=−Vdd,

Vgs (when M2 is on)=−V2=−2 Vdd,

Vgs (when M3 is on)=Vdd−V3=Vdd−3 Vdd=−2 Vdd,

and

Vgs (when M4 is on)=V2−V4=2 Vdd−4 Vdd=−2 Vdd.

In this manner, the gate-to-source voltages Vgs can be provided as-Vdd only on M1 and as −2 Vdd on all M2-M4. Accordingly, this embodiment is equivalent to the third embodiment.

(Seventh Embodiment)

Next, explanation is made on a charge pump circuit according to a seventh embodiment of the invention with reference to FIG. 15. FIG. 15 is a circuit diagram showing a three-staged charge pump circuit for negative voltage boosting (boosting to 0 V or the lower). This charge pump circuit is to output a boost voltage of −3 Vdd.

In FIG. 15, four charge-transfer MOS transistors M1-M4 are connected in series. M1-M4 are all of the N-channel type. M1-M4 are connected to be the same potential at the source and substrate so that a gate-to-substrate voltage Vgb is the same in value as a gate-to-source voltage Vgs. This is to suppress the back gate bias effect. Meanwhile, a ground voltage 0 V is supplied as an input voltage Vin to the source of M1. A boost voltage Vout (−3Vdd) is outputted from the drain of M4 and supplied to a current load L.

C1, C2 and C3 are coupling capacitors having one ends connected respectively to the connection points (pumping nodes) of the charge-transfer MOS transistors M1-M4. The coupling capacitors have the other ends to be applied alternately by a clock pulse CLK and a clock pulse CLKB opposite in phase thereto. The clock pulses CLK, CLKB are supplied through a clock driver CD. Provided that the power voltage to the clock driver CD is Vdd, the clock pulse CLK, CLKB has an amplitude of Vdd.

An output of a level shift circuit S1-S4 is supplied to each gate of the charge-transfer MOS transistor M1-M4. The level shift circuits S1-S4 is the same in configuration as those explained in the foregoing and hence omittedly explained (see FIG. 9). Clock pulses CLK′, CLKB′ are alternately inputted to the level shift circuits S1-S4. The clock pulses CLK′, CLKB′ are similarly supplied through the clock driver CD.

The level shift circuits S1-S4 and the charge pump circuit are in the connection relationship, as follows. A clock pulse CLK′ is inputted to the level shift circuit S1, and supplied with a power voltage Vdd as a higher-potential power and a potential V1 of the connection point of M1 and M2 as a lower-potential power. The level shift circuit S1 outputs “Vdd” to the gate of M1 when the clock pulse CLK′ is at a high level. This turns M1 on. Meanwhile, when the clock pulse CLK′ is at a low level, “V1=−Vdd” is outputted to the gate of M1. This turns M1 off.

The level shift circuit S2 is inputted by a clock pulse CLKB′, and supplied with a power voltage Vdd as a higher-potential power and a potential V2 of a connection point of M2 and M3 as a lower-potential power. The level shift circuit S2 outputs “Vdd” to the gate of M2 when the clock pulse CLKB′ is at a high level. This turns M2 on. Meanwhile, when the clock pulse CLKB′ is at a low level, “V2=−2 Vdd” is outputted to the gate of M1. This turns M2 off.

A clock pulse CLK′ is inputted to the level shift circuit S3, and supplied with a power voltage Vdd as a higher-potential power and a potential V3 of a connection point of M3 and M4 as a lower-potential power. The level shift circuit S3 outputs “Vdd” to the gate of M3 when the clock pulse CLK′ is at a high level. This turns M3 on. Meanwhile, when the clock pulse CLK′ is at a low level, “V3=−3 Vdd” is outputted to the gate of M3. This turns M3 off.

The level shift circuit S4 is inputted by a clock pulse CLKB′, and supplied with a power voltage Vdd as a higher-potential power and an output voltage Vout (=−3 Vdd) as a lower-potential power. The level shift circuit S4 outputs “Vdd” to the gate of M4 when the clock pulse CLKB′ is at a high level. This turns M4 on. Meanwhile, when the clock pulse CLKB′ is at a low level, “Vout” is outputted to the gate of M4. This turns M4 off.

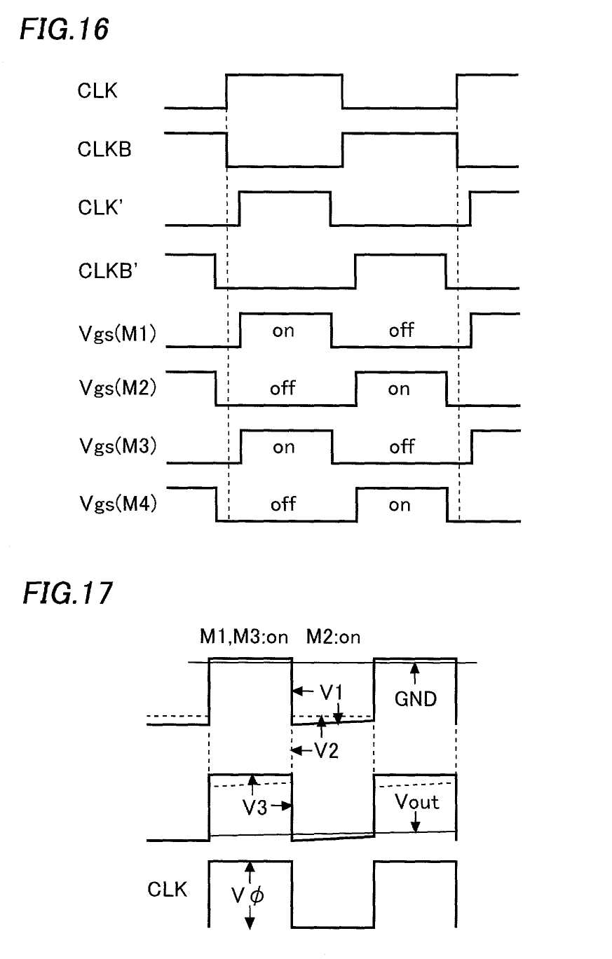

Incidentally, although the clock pulses CLK′ and CLKB′ are respectively produced from the clock pulses CLK and CLKB, the low period is given shorter in order to prevent the reverse flow of a current to the charge-transfer MOS transistors M1-M4. The charge-transfer MOS transistors M1-M4, because of not in diode-connection, have a danger to flow a reverse current that worsens power efficiency. Accordingly, in order to prevent such a reverse current, the charge-transfer MOS transistors M1-M4 are shortened in on-period to change the clock pulses CLK and CLKB applied to the coupling capacitors C1-C3 during the off period, thereby performing pumping. The phase relationship between such clock pulses is shown in FIG. 16.

According to the charge pump circuit configured as above, the gate-to-source voltages Vgs (in on-state of the transistor) in value of the charge-transfer transistors M1-M4 are as in the following.

Vgs (M1)=Vdd−V1

Vgs (M2)=Vdd−V2

Vgs (M3)=Vdd−V3

Vgs (M4)=Vdd−V4

Next, consideration is made on the boost operation of the charge pump in a steady state. FIG. 17 is a chart showing the voltage waveforms V1, V2, V3 and Vout at respective pumping nodes. As apparent from the chart, when M1 and M3 are on (CLK′=H), V1=0 V, V2=−2 Vdd and V3=−2 Vdd.

On the other hand, when M2 and M4 are on (CLKB′=H), V1=−Vdd, V2=−Vdd and V3=−3 Vdd.

Accordingly, the followings hold:

Vgs (when M1 is on)=Vdd−0 V=Vdd,

Vgs (when M2 is on)=Vdd−V2=Vdd−(−Vdd)=2 Vdd,

Vgs (when M3 is on)=Vdd−V3=Vdd−(−2 Vdd)=3 Vdd,

and

Vgs (when M4 is on)=Vdd−V4=Vdd−(−3 Vdd)=4 Vdd.

Accordingly, because high Vgs equal to or greater than 2 Vdd is applied to M2-M4, on-state resistance is reduced in M2-M4 thus realizing a charge pump circuit having high efficiency and great output current. Also, because the charge-transfer MOS transistors M1-M4 are all configured of the N-channel type, manufacture process can be shortened. Incidentally, this embodiment explained the three-staged charge pump circuit, the number of stages is not limited to three.

(Eighth Embodiment)

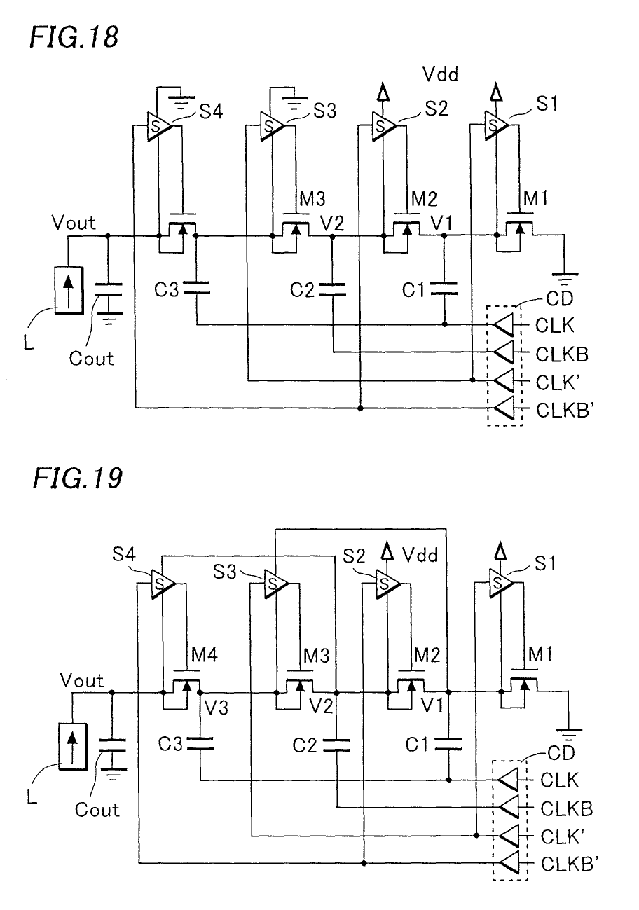

Next, explanation is made on a charge pump circuit according to an eighth embodiment of the invention with reference to FIG. 18. The difference from the seventh embodiment lies in that a ground voltage 0 V is supplied as a lower potential power to the level shift circuit S3 and S4.

Due to this, the gate-to-source voltages Vgs (upon on state of the transistor) in value of the charge-transfer transistors M1-M4 are as in the following.

Vgs (M1)=Vdd−V1

Vgs (M2)=Vdd−V2

Vgs (M3)=−V3

Vgs (M4)=−V4

Herein, the voltages V1, V2, V3 and Vout at the respective pumping nodes in a steady state are the same as those of the seventh embodiment.

Accordingly, the followings holds:

Vgs (when M1 is on)=Vdd,

Vgs (when M2 is on)=2 Vdd,

Vgs (when M3 is on)=−V3=−(−2 Vdd)=2 Vdd,

and

Vgs (when M4 is on)=−V4=−(−3 Vdd)=3 Vdd.

In this manner, the gate-to-source voltages Vgs in an on-state of the charge-transfer transistors M1-M4 are not even. However, the difference can be reduced as compared to that of the seventh embodiment. Accordingly, the charge-transfer MOS transistors M1-M4 may be designed in gate oxide evenly to a thickness for withstanding 3 Vdd (absolute value). Thus, on-state resistance can be designed low to have high efficiency as compared to the seventh embodiment (more uneven in charge-transfer MOS transistor Vgs)

(Ninth Embodiment)

Next, explanation is made on a charge pump circuit according to a ninth embodiment of the invention with reference to FIG. 19. The difference from the fifth embodiment lies in that an intermediate-staged output V1, V2 of the charge pump circuit are supplied as a higher-potential power to the level shift circuit S3, S4.

Due to this, the gate-to-source voltages Vgs (in on-state of the transistor) of the charge-transfer transistors M1-M4 are as in the following.

Vgs (M1)=Vdd−V1

Vgs (M2)=Vdd−V2

Vgs (M3)=V1−V3

Vgs (M4)=V2−V4

Herein, the voltages V1, V2, V3 and Vout at the respective pumping nodes in a steady state are the same as those of the seventh embodiment (see FIG. 17).

Accordingly, the followings hold:

Vgs (when M1 is on)=Vdd,

Vgs (when M2 is on)=2 Vdd,

Vgs (when M3 is on)=V1−V3=0−(−2 Vdd)=2 Vdd,

and

Vgs (when M4 is on)=V2−V4=−Vdd−(−3 Vdd)=2 Vdd.

In this manner, the gate-to-source voltages Vgs can be provided Vdd only on M1 and 2 Vdd on all M2-M4. Accordingly, the charge-transfer MOS transistors M1-M4 may be designed in gate oxide evenly to a thickness for withstanding 2 Vdd (absolute value). Thus, on-state resistance can be designed to be low to have high efficiency as compared to the sixth embodiment (more uneven in charge-transfer MOS transistor Vgs).

(Tenth Embodiment)

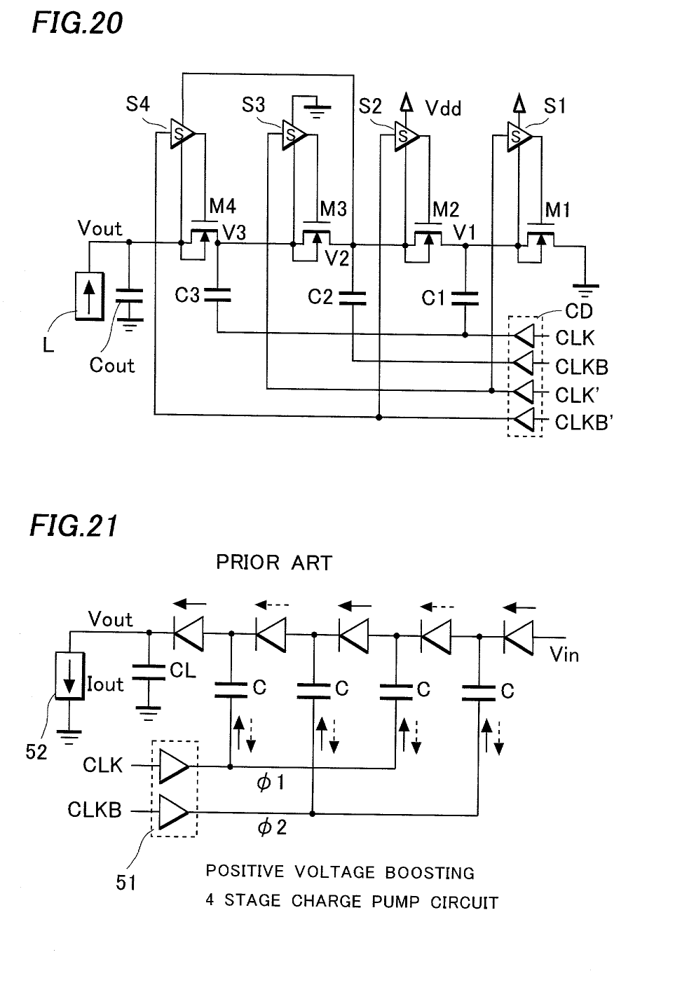

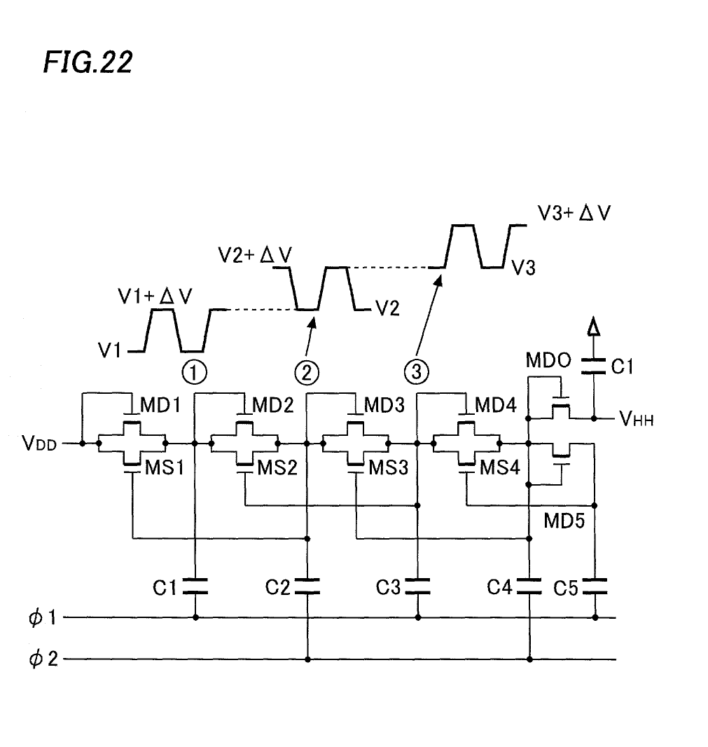

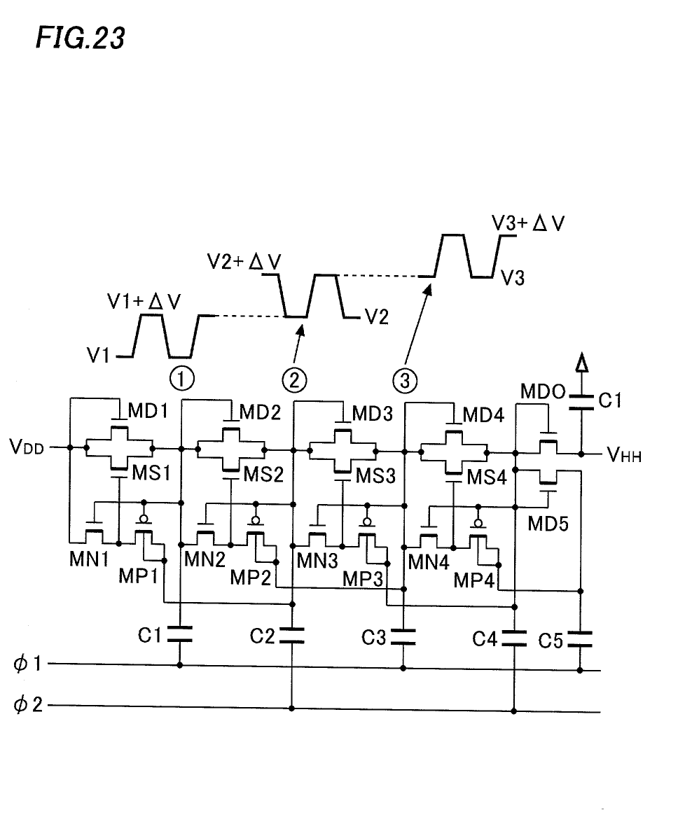

Next, explanation is made on a charge pump circuit according to a tenth embodiment of the invention with reference to FIG. 20. The difference from the fifth embodiment lies in that a ground voltage 0 V is supplied as a higher-potential power to the level shift circuit S3 and an intermediate-staged output V2 of the charge pump circuit is supplied as a higher-potential power to the level shift circuit S4.

Due to this, the gate-to-source voltages Vgs (in on-state of the transistor) of the charge-transfer transistors M1-M4 are as in the following.

Vgs (M1)=Vdd−V1

Vgs (M2)=Vdd−V2

Vgs (M3)=−V3

Vgs (M4)=V2−V4

Herein, the voltages V1, V2, V3 and Vout at the respective pumping nodes in a steady state are the same as those of the seventh embodiment (see FIG. 17).

Accordingly, the followings hold:

Vgs (when M1 is on)=Vdd,

Vgs (when M2 is on)=2 Vdd,

Vgs (when M3 is on)=−V3=−(−Vdd)=2 Vdd,

and

Vgs (when M4 is on)=V2−V4=−Vdd−(−3 Vdd)=2 Vdd.

In this manner, the gate-to-source voltages Vgs can be provided Vdd only on M1 and 2 Vdd on all M2-M4. Accordingly, this embodiment is equivalent to the ninth embodiment.

According to the present invention, because a voltage equal to or higher than a threshold voltage can be applied as a gate-to-source voltage of the charge-transfer MOS transistor, it is possible to provide a charge pump circuit eliminated of voltage loss.

Meanwhile, the high gate-to-source voltage Vgs equal to or higher than an absolute value 2 Vdd reduces the on-state resistance in the charge-transfer MOS transistors M1-M4, realizing a charge pump circuit high in efficiency and large in output current.

Meanwhile, because the gate-to-source voltages and gate-to-substrate voltages of the charge-transfer MOS transistors can be made even to nearly a constant voltage (e.g. 2 Vdd in absolute value), the gate oxide may be designed at a thickness for withstanding generally a constant voltage. This allows to design the on-state resistance low as compared to the case the charge-transfer MOS transistors are uneven in gate-to-source voltage Vgs.

Meanwhile, the invention can provide a charge pump circuit for positive boost and negative boost and arbitrarily set the number of charge pump stages, hence making possible to obtain a desired boost voltage.

Furthermore, the invention can configure the charge-transfer MOS transistors all in the same channel type, thus providing the merit to require the reduced number of manufacture processes.

What is claimed is:

1. A charge pump circuit comprising: a plurality of charge-transfer transistors connected in series; a coupling capacitor having one end connected to each connecting point of the charge-transfer transistors; a clock driver for supplying opposite-phased clock pulses alternately to the other end of the coupling capacitor; a branched charge pump circuit provided branched from the connection point of the charge-transfer transistors; and a control circuit for on/off-controlling the charge-transfer transistor depending upon an output of the branched charge pump circuit.

2. A charge pump circuit comprising: a plurality of charge-transfer transistors connected in series; a plurality of coupling capacitors each having one end connected to each connecting point of the charge-transfer transistors; a clock driver for supplying opposite-phased clock pulses alternately to the other end of each of the coupling capacitors; a plurality of level shift circuits for on/off-controlling the charge-transfer transistor depending upon the clock pulse; and a branched charge pump circuit provided branched from the connection point of the charge-transfer transistors to output a positive boost voltage; whereby an output of each stage of the branched charge pump circuit is used as a higher-potential power to the level shift circuit thereby making a gate-to-source voltage of the charge-transfer transistor of the charge pump circuit upon turning on to nearly a constant value.

3. A charge pump circuit according to claim 2, wherein the branched charge pump circuit comprises a plurality of second charge-transfer transistors connected in series, a plurality of coupling capacitors each having one end connected to each connection point of the second charge-transfer transistors, and a clock driver for supplying opposite-phased clock pulses alternately to the other end of each of the coupling capacitors.

4. A charge pump circuit according to claim 2, wherein the charge-transfer MOS transistor is of an N-channel type.

5. A charge pump circuit comprising: a plurality of charge-transfer transistors connected in series; a plurality of coupling capacitors each having one end connected to each connecting point of the charge-transfer transistors; a clock driver for supplying opposite-phased clock pulses alternately to the other end of each of the coupling capacitors; a plurality of level shift circuits for on/off-controlling the charge-transfer transistor depending upon the clock pulse; and a branched charge pump circuit provided branched from the connection point of the charge-transfer transistors to output a negative boost voltage; whereby an output of each stages of the branched charge pump circuit is used as a lower potential power to the level shift circuit thereby making a gate-to-source voltage of the charge-transfer transistor of the charge pump circuit upon turning on to nearly a constant value.

6. A charge pump circuit according to claim 5, wherein the branched charge pump circuit comprises a plurality of second charge-transfer transistors connected in series, and a plurality of coupling capacitors each having one end connected to each connection point of the second charge-transfer transistors, whereby opposite-phased clock pulses are supplied to the other end of each of said coupling capacitors.

7. A charge pump circuit according to claim 5, wherein the charge-transfer transistor is of a P-channel type.

8. A charge pump circuit comprising: a plurality of P-channel charge-transfer MOS transistors connected in series; a plurality of coupling capacitors each having one end connected to each connecting point of the charge-transfer MOS transistors; a clock driver for supplying opposite-phased clock pulses alternately to the other end of the coupling capacitor; and a plurality of level shift circuits for on/off-controlling the charge-transfer MOS transistor of the charge pump circuit depending upon the clock pulse; whereby an output of each stages of the charge pump circuit is supplied as a higher-potential power to the level shift circuit.

9. A charge pump circuit according to claim 8, wherein a ground voltage is supplied as a lower-potential power to the level shift circuit.

10. A charge pump circuit according to claim 8, wherein the plurality of level shift circuits include part of level shift circuits to be supplied with a ground voltage as a lower-potential power and the other level shift circuits to be supplied with the external voltage as a lower-potential power.

11. A charge pump circuit according to claim 8, wherein the plurality of level shift circuits include part of level shift circuits to be supplied with a ground voltage as a lower-potential power and the other level shift circuits to be supplied with an intermediate-stage output of the charge pump circuit as a lower-potential power.

12. A charge pump circuit comprising: a plurality of N-channel charge-transfer MOS transistors connected in series; a plurality of coupling capacitors each having one end connected to each connecting point of the charge-transfer MOS transistors; a clock driver for supplying opposite-phased clock pulses alternately to the other end of the coupling capacitor; and a plurality of level shift circuits for on/off-controlling the charge-transfer MOS transistor of the charge pump circuit depending upon the clock pulse; whereby an output of each stages of the charge pump circuit is supplied as a lower-potential power to the level shift circuit.

13. A charge pump circuit according to claim 12, wherein a positive external voltage is supplied as a higher-potential power to the plurality of level shift circuits.

14. A charge pump circuit according to claim 12, wherein the plurality of level shift circuits include part of level shift circuits to be supplied with a positive external voltage as a higher-potential power and the other level shift circuits to be supplied with a ground voltage as a higher-potential power.

15. A charge pump circuit according to claim 12, wherein the plurality of level shift circuits include part of level shift circuits to be supplied with the external voltage as a higher-potential power and the other level shift circuits to be supplied with an intermediate-stage output of the charge pump circuit as a higher-potential power.
